(19) United States
(12) Patent Application Publication
(10) Pub. No.: US 2008/0035629 A1
(43) Pub. Date: Feb. 14, 2008

(54) Electrically Heatable Glazing Panel

(75) Inventors: Benoit Thiry, Jumet (BE); Yves Delatte, Jumet (BE)

Correspondence Address: AKERMAN SENTERFITT, P.O. BOX 3188, WEST PALM BEACH, FL, 33402-3188, US

(73) Assignee: Glaverbel-Centre R & D, Jumet (BE)

(21) Appl. No.: 11/572,655

(22) PCT Filed: Jul. 7, 2005
(86) PCT No.: PCT/EP05/53252

§ 371 Date: May 23, 2007

(30) Foreign Application Priority Data
Jul. 26, 2004 (EP) 04103576.7

(51) Int. Cl. H05B 3/84

(52) U.S. Cl. 219/203; 427/108

(57) ABSTRACT

Electrically heatably glazing panel and process for making the same, comprising a substrate, a substantially transparent, electrically conductive coated layer divided into at least two separated zones and at least two spaced bus bars distributing electrical energy to the conductive layer zones. The glazing panel is characterised by the fact that the conductive layer zones have shapes with their longest dimension following the profile of the longest heated substrate edge and extend, at least partly, from the shortest substrate edge towards an opposite short edge of that substrate.

The present invention relates to a glazing panel, which can be heated with electrical energy. In particular, it relates to substantially transparent electrically conductive coating layer deposited on a substrate. More particularly, the invention relates also to heatable automotive side or rear window made of that electrically heatable glazing panel and to a process for heating such an automotive window.

There is known by WO 03/105533 A1 to Glaverbel, an electrically heatable glazing panel comprising several heatable zones, wherein in at least one of the zones the electrical path changes direction so as to double back upon itself. In this glazing panel, the heatable zones are not electrically isolated from one another. It results that complicated folded paths are often required to avoid local overheating in certain regions of the glazing pane.

According to a first aspect, the invention provides an electrically heatable glazing panel as defined in Claim 1.

According to a second aspect, the invention provides a heatable automotive side or rear window made of an electrically heatable glazing panel according to Claim 26.

According to a third aspect, the invention provides a process for heating an automotive side or rear window made of an electrically heatable glazing panel according to Claim 31.

Dependent claims define further preferred embodiments of the invention.

The present invention may provide one or more of the following advantages:
simple design of the conductive layer zones inducing an easy manufacturing process, which can be robotised at rather low costs;
ease of adjusting the intensity of the current flows, hence improving temperature surface homogeneousness;
for slideable opening windows, bus bars may optionally be located near the edges and remain covered by the slide guides.

The glazing panel may be any type of glazing used in the building and in the transportation industries, including, but non-limitatively, glazings for automobiles, trucks, railway and tramway coaches and cars, boats and flying vessels.

The invention relates to glazing panels comprising a substrate and a substantially transparent electrically conductive coated layer. By substantially transparent, it is meaned a layer when, coated on a substrate of 1 to not more than 5 mm thick, transmits visible light at a rate of 50% or better, while it is illuminated with a standard light of A type and observed by a standard observer through a 2° of solid angle (both light and observer CIE normalised). Preferably, the transmission of visible light of that coated substrate is at least 60% in the same standard conditions. Most preferred are the coated substrates having a transmission property in the same conditions of 70% or more.

In addition to the substrate and the electrically conductive coated layer, the glazing panel may optionally also comprise at least one additional layer and/or at least one additional substrate, in whatever order.

The coated layer is electrically conductive in that it allows the passage of the electrical current, opposing only a low electrical resistivity of 1.0 to 10 Ω/square.

According to the invention, the conductive layer is divided into at least two separated zones. The separations should here be understood as electrical separations. They can be implemented in whatever means which are appropriate like, for example, but not limitatively: insertion of a dielectric compound inside thin linear regions of the coated layer and interruption of that layer by interposition of a dielectric material coated on the substrate surface between two layer zones.

Bus bars are also comprised in the glazing panel in order to distribute the electrical current to the conductive layers. In order to properly distribute electrical energy to the conductive layer zones, bus bars are spaced arranged, in view of an easy injection of electrical current on the one sides of conductive layers and an easy collection of that current on an opposite side of those layers.

According to the invention, the conductive layer zones have shapes with their longest dimension following the profile of the longest substrate edge that is heated at full length. By longest dimension of a conductive layer zone following the profile of the longest substrate edge, it should be understood that the longest boundary of a zone follows the path of the substrate edge in a substantially parallel way. In other words, the angle between a tangent drawn at a certain point of the substrate edge and another tangent drawn at the border of a conductive zone at the crossing of a perpendicular straight line to the substrate edge tangent at the considered tangency point with the border line of the conductive zone never exceeds 30°. By substrate edge heated at full length it is meant a substrate heated in a zone approaching the edge at full length at a certain distance of that edge. Said distance may vary from 0 to 5 cm. Moreover, at least part of those conductive layer zones extend from the shortest substrate edge towards an opposite short edge of that substrate. By short edge of a substrate, it is meant an edge whose length is significantly shorter than the substrate's longest edge. Preferably, a short edge's length extends to no higher than 60% of the longest edge's length. More preferably, its length does not extend to more than 40% of the longest edge's one.

In some particular conformations of the glazing panel, where the latter has only two curved edges, conductive layer zones extend generally from one part of the longest edge of the substrate towards another distal part of the same longest edge of the substrate. In another situation where the glazing panel has only two curved edges, conductive layer zones may as well extend from one part of the longest edge towards a distal part of the shortest edge. Still another situation arise when both substrate edges have the same length, conductive layer zones may indifferently extend from a part of one edge to another distal part of the other, or the same edge.

According to a first embodiment of the invention, the glazing panels have a conductive layer divided into more than two separated zones, comprising zones having the shape of substantially parallel conductive stripes. In this embodiment, the stripes of conductive layer may have a comparable width or not. For a particular stripe, the width may remain about the same along the whole length of the stripe. In some circumstances, however, the width of some individual stripes may be varied along their lengths.

In a second embodiment of the glazing panel, at least one of the conductive layer zones is a stripe that starts from any point of the substrate short edge, extends towards the opposite shortest edge, folds upon itself without reaching that opposite shortest edge and turns back towards the starting short edge, establishing a back flow pathway for the electrical heating current. This embodiment may be found in glazing panels where there is an advantage to heat rapidly certain restricted areas of the panel more rapidly and at a slightly higher temperature than the rest of the pane. An example of such areas is an area located in the direct viewing path of a user, such an area having to become as quickly as possible exempt of any mist, ice or water in order to guarantee to that user a secure and perfect vision through the panel. Preferably, in that panel, the turning back conductive stripe is located at a distal region from the substrate longest edge, for example near the opposite edge facing the longest edge.

In another embodiment of the glazing panel, which is compatible with any of the previous ones, the zones are delimited by at least one zone boundary which is substantially insulating. Preferably, insulating zone boundaries are provided by uncoated portions of the glazing panel. Insulating zone boundaries have most often a width of at most 200 μm. Insulating zone boundaries have generally also widths of no less than 5 μm. More preferred are insulating zones of no more than 50 μm wide. Similarly, it is particularly preferred that insulating zone boundaries do not fall under 15 μm wide.

In any one of the preceding embodiments, the coated layer has to possess an electrical resistance per surface unit, or surface resistivity adequate for allowing the flow of a moderate current, capable of generating an adequate amount of heat when a not too dangerously high voltage is applied between bus bars. Preferably, coated layer resistivities of at least 0.5 ohm/square are required. Similarly, higher resistivities than 15 ohm/square are generally not recommended for the coated layer. More preferably, resistivities of at least 2 ohm/square are selected. More preferred as well are resistivities for the coated layer that do not exceed 12 ohm/square.

When the conductive layer is divided into zones of substantially parallel conductive stripes, it is often an advantage that each parallel stripe has substantially the same electrical resistance in order not to create too hot spots on the panel. However, shape constraints for the panel or other constraints sometimes impose that stripes do not all have the same length. One solution to the problem of equal resistance may be in this situation to vary the width of the conductive stripes when the resistivity of the coated layer is constant across stripes, making the latter thinner for those having shorter length so as to maintain their overall electrical resistance substantially constant. In other circumstances, one may also wish sometimes to heat quicker and at a bit higher temperature certain areas, as explained above. Vary the width of stripes of equal length may as well be a solution to solve that last problem. A way to make conductive stripes thinner may be to realise in their region of the panel broader zone boundaries than in the remaining regions. This may be implemented in different ways. One way is to realise insulating zone boundaries in those regions by having them take the shape of broad stripes of conductive coated layers the continuity of which has been interrupted in order to stop the current flow through them. Another way, equally interesting, consists in realising in the region broad stripes of conductive coated layers, at least one of the extremities of which is not electrically connected, for example, with no electrical connection to one of spaced bus bars.

Another embodiment of the glazing panel, which is preferred and especially compatible with any of the previous ones, is to have a glass sheet for the substrate. Alternatively, the substrate may as well be any type of transparent inorganic material. An example of such inorganic material may be transparent plastic compound.

In still another embodiment, the glazing panel may have been thermally toughened in order to give it particular mechanical properties.

Another alternative glazing panel according to the invention is a laminated glazing. The laminated panel may be formed from any number of elementary sheets and/or films. A preferred glazing is the one comprising at least two outer sheets of glass and at least one inner sheet of a plastic transparent material as, for example films made of polyvinylbutyral or ethylene-vinylacetate copolymers, otherwise also called acetic esters of polyvinyl alcohol (“PVB” or “EVA” films) and polyethyethyleneterephtalate esters sheets (“PET”). Most preferred are laminates consisting of two sheets of glass sandwiching one or several PVB, EVA films and/or PET sheets. A laminated glazing panel having given good results is the following: Glass sheet—PVB film—PET sheet coated with an electrically conductive layer—PVB film—Glass sheet. In that laminated glazing, Cu bus bars are interposed at both extremities of the panel between one of the PVB films and the conductive layer coated on the PET sheet.

A small contact resistance generally takes place at the junction of the bus bars and the electrically conductive layer. Sometimes this small resistance is not exactly the same along the entire bus bar length. In order to minimize that contact resistance and to keep it perfectly constant along the entire bus bars lengths, some conductive paste may be interposed between the bus bars and the electrically conductive layer. Examples of such conductive pastes are, non-limitatively, an epoxy setting conductive resin and a silver based paste.

A glazing panel according to the invention may be used as a part or total side or rear panel of an automotive window. “Automotive” should be taken here in its extensive meaning, as defined above.

An interesting embodiment for an automotive glazing panel according to the invention comprises bus bars located near the edges of the panel in areas that are masked by the automotive body when the glazing panel is completely shutting a window of that automotive vehicle.

In all embodiments of the glazing panel according to the invention, the electrically conductive coated layer may be deposited directly on a glass surface substrate. Alternatively, the electrically conductive coated layer may as well be carried by a plastic sheet assembled as part of the glazing panel. In the last configuration, the electrically conductive coated layer is generally included inside a laminate glass. A preferred sheet for carrying the electrically conductive layer is PET.

The nature and composition of the electrically conductive layer may be any complex stack comprising at least one elementary layer that is electrically conductive due to the presence of a metal and/or a metal oxide doped with elements like Sb, Al, In, Sn and F. Generally the elementary conductive layer is protected between at least two dielectric layers, most often metal oxide layers. Solar control functional layers comprising metal layers like Ag may also be used as conductive stack. Stacks that have given good results are the Southwall XIR®70 and XIR®75 conductive layers coated on PET sheets.

Composition and surface resistivity of the conductive coated layer have to be carefully controlled so as the variation in temperature across all zones of the glazing panel is less than 20° C. in non transient conditions when a voltage difference is applied across the coated layer by means of at least two opposite bus bars when there is no heat transfer by convection between the panel and its surrounding atmosphere.

Where conductive zones take the shape of substantially parallel stripes, the stripes that may have one of their ends located anywhere along the edge facing opposite to the longest edge of the substrate may also have their bus bars laid substantially perpendicular to the direction of the end portions of the conductive stripe.

In some configurations of the glazing panel according to the invention, at least two contiguous conductive stripes may be connected at at least one of their ends to electrical bus bars which are themselves connected together.

The invention deals as well with a heatable automotive side or rear window made of an electrically heatable glazing panel comprising a substrate, a substantially transparent, electrically conductive coated layer divided into at least two separated zones and at least two spaced bus bars distributing electrical energy to the conductive layer zones. The side windows is characterised in that the conductive layer zones have shapes with their longest dimension substantially parallel to the longest edge of the substrate that is heated at full length and extend from the shortest edge of the substrate towards an opposite short edge of that substrate.

What have been described in detail for the glazing panel according to the invention applies as well, mutatis mutandis to the heatable automotive side or rear windows.

A preferred embodiment of the heatable automotive side or rear windows is the one wherein the electrically heatable glazing panel is able to open the window by sliding out of a window frame through at least one of the window edges while uncovering the longest substrate edge of the panel.

The invention deals as well with a process for heating an automotive side or rear window made of an electrically heatable glazing panel comprising a substrate, a substantially transparent, electrically conductive coated layer divided into at least two separated zones and at least two spaced bus bars distributing electrical energy to s the conductive layer zones, characterised in that an electrical current is forced in the conductive layer zones and in that the zones have been shaped with their longest dimension substantially parallel to the longest edge of the substrate that is heated at full length so as to extend from the shortest edge of the substrate towards an opposite short edge of that substrate.

The invention deals as well with a heatable automotive side or rear window made of an electrically heatable glazing panel able to open the window by sliding out of a window frame through at least one of the window edges while uncovering a substrate edge of the panel and comprising, coated on the substrate, a substantially transparent, electrically conductive coated layer divided into at least two separated zones and further comprising at least two spaced bus bars distributing electrical energy to the conductive layer zones, characterised in that the conductive layer zones have shapes with their longest dimension substantially parallel to the uncovered edge of the substrate

All the specific terms used here for the process have the same meaning as those already defined for the glazing panel.

The examples that follow are aiming at providing a better description of the invention, without restricting its scope.

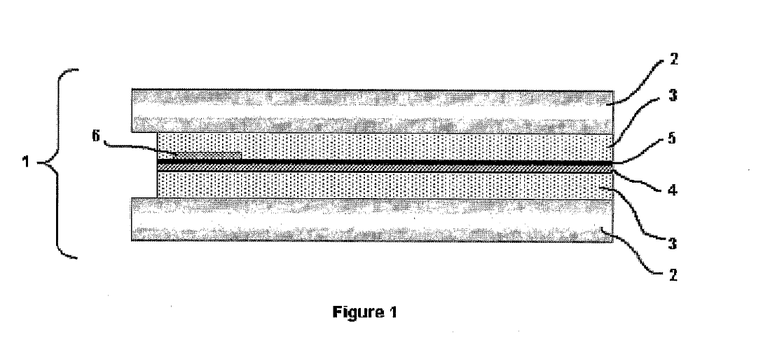

FIG. 1 which follows illustrates a laminated glazing panel 1 according to the invention (the left cut part of which being represented on the figure). Between two sheets of clear glass of 2.1 mmm thick 2, there are two films of PVB 3 of 0.38 mm thick sandwiching a PET sheet 4 of 25 to 50 μm coated with a conductive layer 5 of 10 μm thick. Copper bus bars 6 of 5 mm wide and 50 μm thick were interposed at two opposite sides of panel 1, between one PVB layer 3 and the conductive layer 5.

An automobile heatable front left side glazing panel has been manufactured by first laying down on a plane glass plate a bi-layer sheet consisting of a first sheet of PVB Saflex® AR11 0.38 mm thick and a second sheet of PET coated with a conductive electrical film (trademark Southwall XIR® 70) 50 μm thick on top. The bi-layer sheet was then submitted to the sweep of a laser beam in order to cut thin parallel grooves of about 100 μm at intervals into the conductive top coat so as to realise electrical isolation between the conductive stripes produced. Two copper foil ribbons of 3 mm wide and 0.05 mm thick (resistivity 2 μΩ.cm) were then laid at each opposite side of a zone that was intended to heat, near the edges of the bi-layer sheet so as to electrically connect all conductive zones at each of their extremities by a kind of bus bar. At each end of the copper foil ribbons, an electrical current feeder connector made of a copper sheet of 10 mm wide and 0.1 mm thick was laid down, the emerging part of the copper sheets being then coated on their both sides with a kapton isolating sheet that was welded at the copper sheet edges.

The bi-layer sheet with conductive stripe zones and electrical connectors was then removed from the glass plate and laid down onto another sheet of PVB Saflex® AR11 0.38 mm thick so as to sandwich the electrical conductive layer coated on PET sheet between the two PVB outer layers. A few spots were then welded by hot-plate conduction welding in order to mechanically hold all sheets together in a laminated structure.

The multilayer structure was then interposed between two clear bended glass sheets of 2.1 mm thick and the whole was allowed to enter an autoclave wherein it was submitted to an elevated temperature up to 140° C. under an overpressure of up to 14 bar in order to eliminate gas bubbles and stick all sheets together.

Two different configurations of copper bus bars were realised: in strait lines and in zigzags (bus bars being about perpendicular to each conductive layer stripe in the latter configuration).

After cooling down, optical properties of the panel has been determined and have given the following results, summarised in table 1:

TABLE 1

| Colour | | | Transmission | | Reflection | Solar Factor | |
|---|---|---|---|---|---|---|---|
| L* | a* | b* | LTA | TSET | ER | SF₀ | SF₁₀₀ |
| 33.8 | −3.1 | 1.1 | 74 | 45.5 | 24 | 53.4 | 47.6 |

In table 1, colour has been measured according to the CIE L, a*, b* system with a standard illuminant normalised by the International Commission of Lightning (CIE) approaching daylight and called D65. Observations were made through a solid angle of 10° and with an incident light beam of 0° compared to the perpendicular to the panel surface. The following symbols apply, for the remaining measures:
LTA: luminous transmission through the glazing under illuminant A (CIE), in % of the incident light;
TSET: total solar energy transmittance, in % of the incident radiation;
ER: energetic reflection, in % of the incident radiation;
SF₀: solar factor in the absence of convection (speed=0 km/h);
SF₁₀₀: solar factor under a convection flow corresponding to a speed of 100 km/h.

Table 2 which follows gives the electrical characteristics of the panel:

TABLE 2

| | Current, | Voltage, | Power, | Specific power, |
|---|---|---|---|---|
| Bus bars | A | V | W | W/m² |
| Straight lines | 2.80 | 42 | 118 | 535 |
| Zigzags | 2.65 | 42 | 111 | 506 |

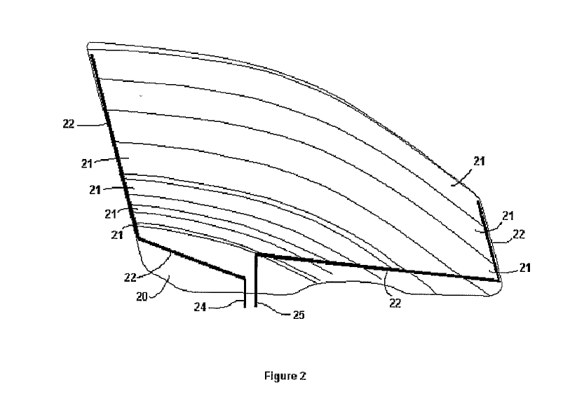

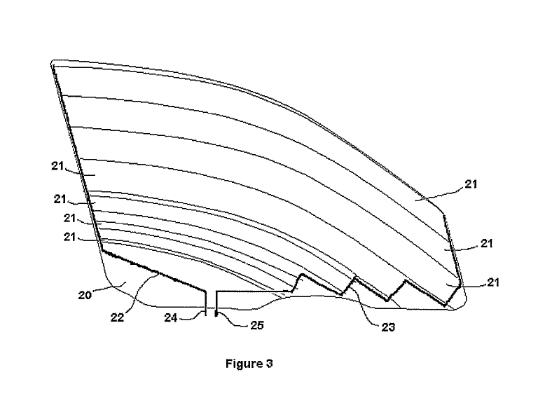

At FIGS. 2 and 3 are illustrated automotive windows 20 with parallel conductive stripes 21 and straight lines copper foil bus bars (22, FIG. 2) or zigzag copper foil bus bars that have been folded to follow a “stair” path (23, FIG. 3). At 24 and 25 are found the connectors.

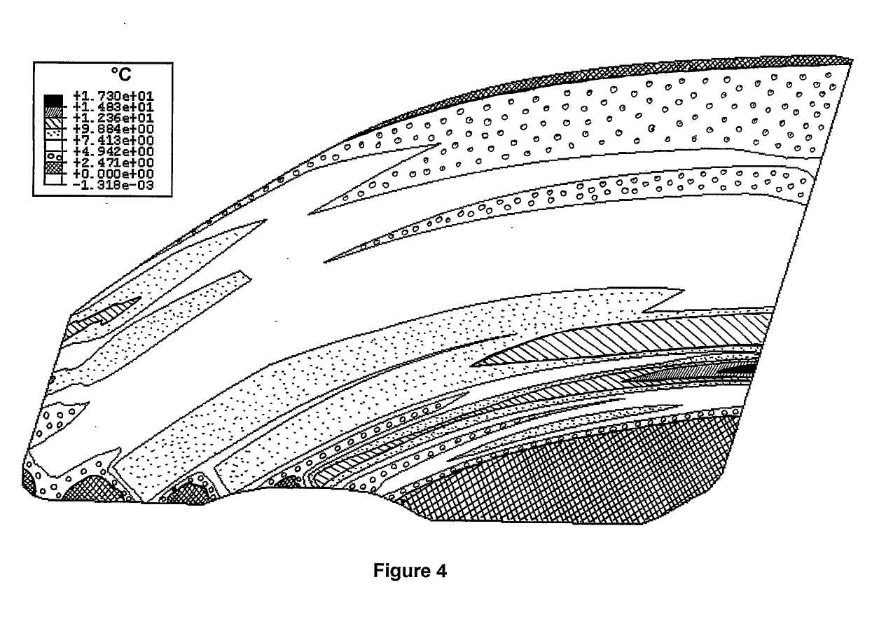

FIG. 4 shows the image obtained with an IR camera in steady state conditions of panel heating.

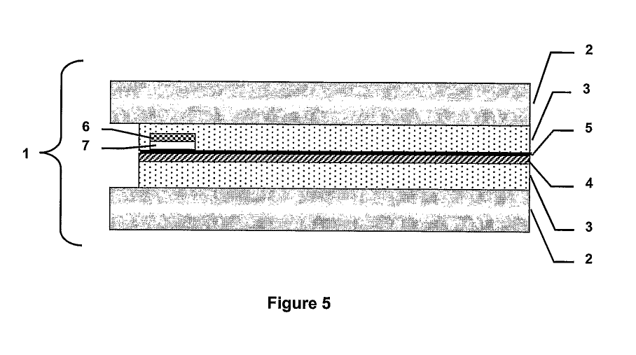

FIG. 5 illustrates an alternative laminated glazing panel 1 according to the invention (the left cut part of which being represented on the figure). The glazing panel advantageously comprises improved contacts between the bus bars and the electrically conductive layer. Between two sheets of clear glass of 2.1 mmm thick 2, there are two films of PVB 3 of 0.38 mm thick sandwiching a PET sheet 4 of 25 to 50 μm coated with a conductive layer 5 of 10 μm thick. Copper bus bars 6 of 5 mm wide and 50 μm thick bearing an epoxy conductive resin layer 7 were interposed at two opposite sides of panel 1, between one PVB layer 3 and the conductive layer 5.

1. An electrically healable glazing panel comprising a substrate, a substantially transparent, electrically conductive coated layer divided into at least two separated zones and at least two spaced bus bars distributing electrical energy to the conductive layer zones, characterised in that the conductive layer zones have shapes with their longest dimension following the profile of the longest substrate edge that is heated at full length and extend, at least partly, from the shortest substrate edge towards an opposite short edge of that substrate.

2. The glazing panel according to claim 1, characterised in that the conductive layer is divided into more than two separated zones, comprising zones that have the shape of substantially parallel conductive stripes.

3. The glazing panel according to claim 1, characterised in that at least one of the conductive layer zones is a stripe that starts from any point of the substrate short edge, extends towards the opposite shortest edge, folds upon itself without reaching that opposite shortest edge and turns back towards the starting short edge, establishing a back flow pathway for the electrical heating current.

4. The glazing panel according to claim 3, characterised in that the turning back conductive stripe is located at a distal region from the substrate longest edge.

5. The glazing panel according to claim 1, characterised in that the zones are delimited by at least one zone boundary which is substantially insulating.

6. The glazing panel according to claim 5, characterised in that one or more insulating zone boundaries are provided by uncoated portions of the glazing panel.

7. The glazing panel according to claim 5, characterised in that the insulating zone boundaries have a width of at most 200 pm.

8. The glazing panel according to claim 1, characterised in that the coated layer has an electrical surface resistivity from 0.5 to 15 ohm/square.

9. The glazing panel according to claim 2, characterised in that each conductive stripe has substantially the same electrical surface resistance.

10. The glazing panel according to claim 9, characterised in that all conductive stripes have not the same length.

11. The glazing panel according to claim 10, characterised in that the width of the conductive stripes are thinner for shorter stripes so as to maintain their electrical resistance substantially constant.

12. The glazing panel according to claim 11, characterised in that insulating zone boundaries are broader In regions of the glazing panel where the conductive stripes are thinner.

13. The glazing panel according to claim 12, characterised in that in regions where the conductive stripes are thinner, insulating zone boundaries take the shape of broad stripe of conductive coated layers the continuity of which has been interrupted in order to stop the current flow.

14. The glazing panel according to claim 12, characterised in that in regions where the conductive stripes are thinner, insulating zone boundaries take the shape of broad stripe of conductive coated layers which at least one of their extremities is not electrically connected.

15. The glazing panel according to claim 1, characterised in that the substrate is a glass sheet.

16. The glazing panel according to claim 1, characterised in that it is thermally toughened.

17. The glazing panel according to claim 1, characterised in that it is laminated.

18. The glazing panel according to claim 1, characterised in that it is part of an automotive side or rear window.

19. The glazing panel according to claim 18, characterised in that bus bars are located near the edges of the panel in areas which are masked by the automotive vehicle body when the glazing panel is completely shutting a window of the vehicle.

20. The glazing panel according to claim 1, characterised in that a conductive paste is interposed between bus bars and the electrically conductive layer.

21. The glazing panel according to claim 1, characterised in that the electrically conductive coated layer is deposited directly on a glass surface substrate.

22. The glazing panel according to claim 1, characterised in that the electrically conductive coated layer is carried by a plastic sheet assembled as part of the glazing panel.

23. The glazing panel according to claim 1, characterised in that the variation in temperature across all zones is less than 20° C. in non transient conditions when a voltage difference is applied across the coated layer by means of at least two opposite bus bars and there is no heat transfer by convection between the panel and its surrounding atmosphere.

24. The glazing panel according to claim 2, characterised in that each conductive stripe, which has one of its ends anywhere along the edge opposite to the longest edge of the substrate, has its bus bars laid substantially perpendicular to the direction of the end portions of the conductive stripe.

25. The glazing panel according to claim 2, characterised in that at least two contiguous conductive stripes are connected at at least one of their ends to electrically connected bus bars.

26. A heatable automotive side or rear window made of an electrically heatable glazing panel comprising a substrate, a substantially transparent, electrically conductive coated layer divided into at least two separated zones and at least two spaced bus bars distributing electrical energy to the conductive layer zones, characterised in that the conductive layer zones have shapes with their longest dimension substantially parallel to the longest edge of the substrate that is heated at full length and extend from the shortest edge of the substrate towards an opposite short edge of that substrate.

27. A heatable automotive window according to claim 26, characterised in that the zones are delimited by at least one zone boundary which is substantially insulating.

28. A heatable automotive window according to claim 26, characterised in that the conductive layer of the glazing panel is divided into more than two separated zones that have the shape of substantially parallel stripes.

29. A heatable automotive window according to claim 28, characterised in that at least one conductive layer stripe has at least one of opposite spaced bus bars substantially perpendicular to the direction of the end portion of the conductive stripe.

30. A heatable automotive side window according to claim 26, characterised in that the electrically heatable glazing panel is able to open the window by sliding out of a window frame through at least one of the window edges while uncovering the longest substrate edge of the panel.

31. Process for heating an automotive side or rear window made of an electrically heatable glazing panel comprising a substrate, a substantially transparent, electrically conductive coated layer divided into at least two separated zones and at least two spaced bus bars distributing electrical energy to the conductive layer zones, characterised in that an electrical current is forced in the conductive layer zones and in that the zones have been shaped with their longest dimension substantially parallel to the longest edge of the substrate that is heated at full length so as to extend from the shortest edge of the substrate towards an opposite short edge of that substrate.

32. A heatable automotive side or rear window made of an electrically heatable glazing panel able to open the window by sliding out of a window frame through at least one of the window edges while uncovering a substrate edge of the panel and comprising, coated on the substrate, a substantially transparent, electrically conductive coated layer divided into at least two separated zones and further comprising at least two spaced bus bars distributing electrical energy to the conductive layer zones, characterised in that the conductive layer zones have shapes with their longest dimension substantially parallel to the uncovered edge of the substrate.
